(19) United States
(12) Patent Application Publication
(10) Pub. No.: US 2012/0021855 A1
(43) Pub. Date: Jan. 26, 2012

(54) Contact sport

(76) Inventor: Robert Dwight Brown, Pueblo, CO (US)

(21) Appl. No.: 13/136,244

(22) Filed: Jul. 26, 2011

Related U.S. Application Data
(60) Provisional application No. 61/367,791, filed on Jul. 26, 2010.

(51) Int. Cl. A63B 67/00; A63F 13/00; A63B 71/02

(52) U.S. Cl. 473/470; 473/465; 463/4

(57) ABSTRACT

A contact sport that provides for individuals to excel without requiring teamwork while simultaneously allowing multiple players to participate in the same contact sport game is described. An individual offensive player advances a ball on a playing field towards an active end zone. A plurality of defensive players each attempts to keep the offensive player from advancing. If the offensive player is successful, points are scored. If defensive player(s) are successful, the offensive player must relinquish control and the defensive player(s) may score points. The game continues as one of the former defensive players gains control of the ball, becomes the new offensive player, and attempts to advance the ball. The playing field can be a surface located indoors or outdoors and is not limited to a rectangular shape, although the standard size and shape of a football field can be utilized in a preferred embodiment.

### CROSS-REFERENCE TO RELATED APPLICATIONS

This application claims the benefit of U.S. Provisional Application No. 61/367,791 entitled “Individual Contact Sport” and filed on Jul. 26, 2010.

### TECHNICAL FIELD

The invention relates generally to sports and recreation and more particularly, but not by way of limitation, to a contact sport played on a field by a number of individuals.

### BACKGROUND

There are many different types of contact sports that can be played in a myriad of different ways, examples include: American football (hereinafter “football”), rugby, international football (hereinafter “soccer”), ice hockey, water polo, etc. A limitation inherent in each of these sports is that they are team-based. Superior individual participants can make a name for themselves, but often their individual performance is hampered or at least limited by the performance of other players on their team and/or their team as a whole. Furthermore, inter-player cooperation is vital to success and requires that players work together, limiting opportunities for excelling individually. As an alternative, individual contact sports can be played, including: wrestling, boxing, and martial arts. However, each of these sports is played one-on-one where two individuals face off against each other and do not allow for more than two participants at a time to use the field or facility. Further limitations of these individual contact sports include: if a participant needs to rest or is injured, the other participant is also forced to stop playing; participants can not be easily or fairly substituted or added to an ongoing game; such sports are often seen as somewhat brutal in that the goal of the sport is to incapacitate or otherwise injure the opposing participant; etc.

To avoid these significant limitations, team contact sports as discussed above can be played. However, such sports not only force players to cooperate and share success, but can make it difficult for a group of people to spontaneously play the sport: teams must be decided and the same players must gather together for each game and any practices, players may not easily join or leave the team or game, and generally only a certain fixed number of players can play at one time.

What is needed is a contact sport that overcomes the above limitations by: allowing individual participants to excel, rewarding individual skills and play, allowing multiple players to participate at once, permitting the total number of players to vary, providing for individual players to rest or otherwise step out of the game without stopping play, requiring a strategic goal that encourages individuals to improve their skills rather than simply incapacitating an opponent, and not necessarily requiring any cooperation or teamwork.

### SUMMARY

One embodiment of the present invention is a method of playing a game which provides for individuals to excel without requiring teamwork while simultaneously allowing multiple players to participate in the same contact sport game at once. In an exemplary embodiment, an individual offensive player carries a ball on a generally rectangular playing field towards an active end zone or point scoring area (a second, currently inactive, end zone is positioned at the opposite end of the field). A plurality of defensive players each aggressively attempts to keep the offensive player from moving the ball into the active end zone. If the offensive player is successful, he or she scores points. If one or more of the defensive players are successful, the offensive player must relinquish control of the ball and the defensive player(s) may score points for forcing the change of possession. The game continues as one of the former defensive players gains control of the ball, becomes the new offensive player, and attempts to move the ball towards the most distant scoring area (determined at the time he or she gained control of the ball). The previous offensive player now joins the ranks of defensive players and attempts to stop the new offensive player from scoring. The playing field can be a surface located indoors or outdoors and is not limited to a rectangular shape, although the standard size and shape of a football field can be utilized in a preferred embodiment. It should be understood that many embodiments of the present invention may be practiced without departing from the scope of the invention.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a top plan view of an exemplary embodiment of a playing field that can be employed when playing an embodiment of the contact sport of the present invention;

FIG. 2 illustrates an exemplary embodiment of the contact sport of the present invention;

FIG. 3 illustrates an exemplary embodiment of a computing system useful in implementations of the described invention.

### DETAILED DESCRIPTION

In the following discussion, numerous specific details are set forth to provide a thorough understanding of the present invention. However, those skilled in the art will appreciate that the present invention may be practiced without such specific details. Furthermore, lists and/or examples are often provided and should be interpreted as exemplary only and in no way limiting embodiments to only those examples.

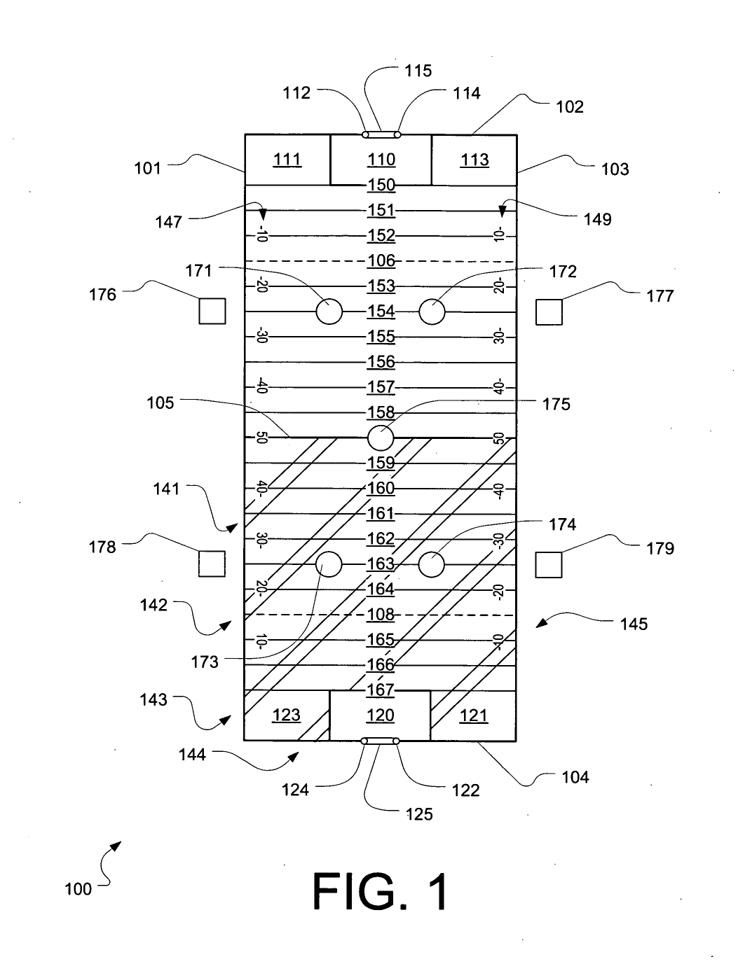

Referring now to the drawings, FIG. 1 illustrates a top plan view of an exemplary embodiment of a playing field 100 that can be employed when playing an embodiment of the contact sport of the present invention. The field 100 is preferably a standard football field but can be other shapes and sizes without departing from the scope of the invention. In the embodiment shown in FIG. 1, the field 100 is rectangular in shape and is defined by a first sideline 101, a first end line 102, a second sideline 103, and a second end line 104. The first and second sidelines 101 and 103 should be the same general length and approximately three hundred and sixty feet is a preferred length. The first and second end lines 102 and 104 should be the same general length and approximately one hundred and sixty feet is a preferred length.

At each end of the field, the final ten yards of the field define three rectangular areas. In other embodiments, these areas can have other shapes, but those shown in the embodiment of FIG. 1 are preferred. At the top of FIG. 1 are the first negative yard area 111, the second negative yard area 113 and the first end zone 110. The first negative yard area 111 is bounded on the bottom by the first goal line 160, on the left by the first side line 101, on the top by the first end line 102, and on the right by the first end zone 110. The end zone 110 is bounded on the bottom by the first goal line 160, on the left by the first negative yard area 111, on the top by the first end line 102, and on the right by the second negative yard area 113. The second negative yard area 113 is bounded on the bottom by the first goal line 160, on the left by the first end zone 110, on the top by the first end line 102, and on the right by the second side line 103.

In the embodiment shown in FIG. 1, the first and second negative yard areas 111 and 113 and the first end zone 110 are all ten yards deep. The first and second negative yard areas 111 and 113 are fifty feet wide and the first end zone 110 is sixty feet wide in the embodiment of FIG. 1. In other embodiments, other dimensions are contemplated. Located at approximately the center of the first end line 102 is the first goal post 115. It can be shaped and sized as any football goal post, usually having a horizontal cross member located approximately ten feet off the ground and connecting two vertical uprights that are spaced approximately eighteen to twenty four feet apart. A plurality of indicators can be positioned in proximity to the first goal post 115. In the embodiment in FIG. 1, the indicators comprise a first red light 112 and a first green light 114; they can be positioned near the first goal post 115. When the first end zone 110 is active, the first green light 114 can be activated and the first red light 112 can be deactivated. When the first end zone 110 is not active, the first green light 114 can be deactivated and the first red light 112 can be activated. Although these lights are useful for orienting the players during a game, they are not necessary. Furthermore, although the first goal post 115 enhances the game, it also is not strictly necessary.

The first goal line 150 can also be referred to as the first zero yard line, hence the term “negative yard” when referring to the first and second negative yard areas 111 and 113. The next yard line heading down the field is the first five yard line 151, next is the first ten yard line 152, then the first red zone line 106 (also called the first fifteen yard line), followed by: the first twenty yard line 153, the first twenty five yard line 154, the first thirty yard line 155, the first thirty five yard line 156, the first forty yard line 157, the first forty five yard line 158, the fifty yard line 105, the second forty five yard line 159, the second forty yard line 160, the second thirty five yard line 161, the second thirty yard line 162, the second twenty five yard line 163, the second twenty yard line 164, the second red zone line 108 (also called the second fifteen yard line), the second ten yard line 165, the second five yard line 166, and the second goal line 167 (or second zero yard line). Although these yardage lines help the players orient themselves on the field 100, they are not strictly necessary to play the contact sport of the present invention. Markers such as cones or other visible indicators can be used instead of lines to delineate the field 100, the first and second end zones 110 and 120, and the first and second red zone lines 106 and 108 (and other lines, etc. as desired).

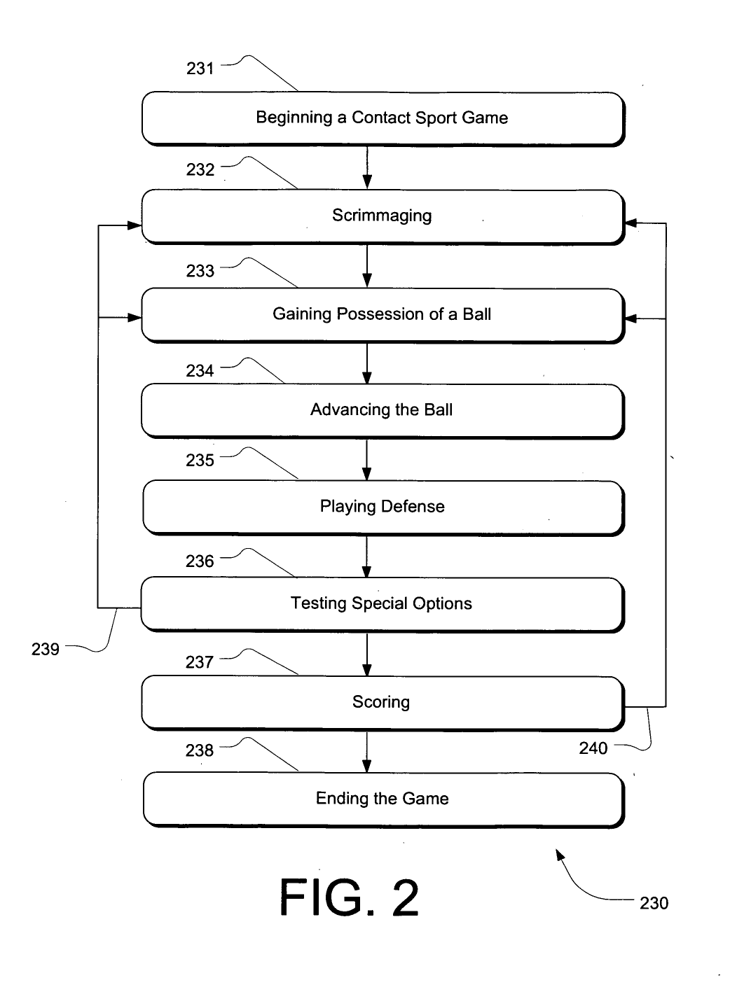

The space between the first red zone line 106 and the first end line 102, not including the first end zone 110, and the space between the second red zone line 108 and the second end line 104, not including the second end zone 120, are called red zones. The red zone nearest to the active end zone is called the active red zone. In some embodiments, additional defensive scoring opportunities or bonus points can be awarded if events occur in the active red zone (see FIG. 2, Scoring 237 below).

In the embodiment shown in FIG. 1, the third and fourth negative yard areas 121 and 123 and the second end zone 120 are all ten yards deep. The third and fourth negative yard areas 121 and 123 are fifty feet wide and the second end zone 120 is sixty feet wide in the embodiment of FIG. 1. In other embodiments, other dimensions are contemplated. Located at approximately the center of the second end line 104 is the second goal post 125. It can be shaped and sized as any football goal post, usually having a horizontal cross member located approximately ten feet off the ground and connecting two vertical uprights that are spaced approximately eighteen to twenty four feet apart. A plurality of indicators can be positioned in proximity to the second goal post 125. In the embodiment shown in FIG. 1, the indicators comprise a second red light 122 and a second green light 124; they can be positioned near the second goal post 125. When the second end zone 120 is active, the second green light 124 can be activated and the second red light 122 can be deactivated. When the second end zone 120 is not active, the second green light 124 can be deactivated and the second red light 122 can be activated. Although these lights are useful for orienting the players during a game, they are not necessary. Furthermore, although the second goal post 125 enhances the game, it also is not strictly necessary.

The field 100 is split in half by the fifty yard line 105. The second half can be distinguished from the first half by the addition of chalk lines 141, 142, 143, 144, and 145 running at some angle across the second half of the field. In FIG. 1, the chalk lines 141-145 are shown as approximately two and a half yards wide and running at an approximately forty five degree angle to the first side line 101. Although the chalk lines 141-145 can be useful to help players orient themselves on the field 100, they are not strictly necessary to play the contact sport of the present invention.

Similarly, running down both sides of the field 100 are columns of yardage numbers. The first yardage column 147 runs generally parallel to the first side line 101 and the second yardage column 149 runs generally parallel to the second side line 103. These yardage numbers help the players orient themselves on the field 100, but they are not strictly necessary to play the contact sport of the present invention.

Five scrimmage rings 171, 172, 173, 174 and 175 can be found on the field 100. In the embodiment shown in FIG. 1, the first and second scrimmage rings 171 and 172 are centered on the first twenty five yard line 164 and are each located approximately fifty feet from their respective side lines 101 and 103. The third and fourth scrimmage rings 173 and 174 are centered on the second twenty five yard line 173 and are each located approximately fifty feet from their respective side lines 101 and 103, in the embodiment shown in FIG. 1. The fifth scrimmage ring 175 should be located in the center of the field 100 such that it is also in the center of the fifty yard line 105. The scrimmage rings 171-175 area shown in FIG. 1 as being generally circular in shape and having a diameter of approximately five yards, in other embodiments, other shapes and sizes are contemplated. For example, the scrimmage rings 171-175 can comprise a simple “x” or other indicator on the field at which the referees have the players form a scrimmage (see below for a description of a scrimmage). Furthermore, the number of scrimmage rings can vary without departing from the scope of the invention.

At approximately the first twenty five yard line 164, but located outside of the main portion of the field that lies between the first and second side lines 101 and 102 are located a first penalty box 176 and a second penalty box 177. At approximately the second twenty five yard line 173, but located outside of the main portion of the field that lies between the first and second side lines 101 and 102 are located a third penalty box 178 and a fourth penalty box 179. In other embodiments, the penalty boxes can be sized, shaped, and located differently from those shown in FIG. 1. Furthermore, the number of penalty boxes can vary without departing from the scope of the invention.

As mentioned above, the contact sport of the present invention can be played on fields that differ in some respects from the embodiments detailed above and in FIG. 1. For example, although the surface of the playing field should be covered in grass, other usable playing surfaces include artificial turf (low nap synthetic grass surface), dirt, mud, snow, ice, wood flooring, other interior flooring, etc. Although it is possible to play the contact sport on gravel, concrete, etc., it is not advisable, as the potential for player injuries increases significantly when played on such surfaces. Other examples of differing yet acceptable fields include, either singly or in combination: soccer fields, lacrosse fields, field hockey fields, polo fields, football fields, other fields, sand beaches/stretches, water, parks, meadows, etc. The dimensions detailed above should be used as general guidelines, but acceptable fields can vary significantly without departing from the scope of the invention. Furthermore, the shape of the field does not have to be a strict rectangle, it can be a trapezoid, oval, square or other parallelogram, or an irregular sided polygon and/or it can incorporate one or more curves as well.

FIG. 2 illustrates an exemplary embodiment of the contact sport of the present invention 230. The method shown in FIG. 2 starts with the process of Beginning a Contact Sport Game 231. The Beginning process 231 comprises: selecting a field on which to play (as noted above, a field 100 similar to that illustrated in FIG. 1 is recommended, but other fields may be used); choosing a beginning number of players; selecting a ball, flag or other object (hereinafter “ball”) for the offensive player to carry; deciding on whether the offensive player will be an individual, doubles, triples, quads, etc.; and gathering the players on the field 100.

In one embodiment, the number of players is set at fifteen starting players with three players in reserve. However, the number of players can vary and twelve or twenty starting players are also common choices. In other embodiments, the numbers of starting and reserve players can be fewer than or more than fifteen and three, respectively.

In one embodiment, the ball is selected to be generally the shape and dimensions of a standard rugby ball. In other embodiments, footballs, soccer balls, flags, or any other appropriate objects can be used. General guidelines are that the ball should be rugged and it should be something that can be kicked and thrown. Furthermore, the ball should not be unduly risky for a player to land upon if tackled, tripped, etc.

In one embodiment, the offensive player is limited to one person at a time (called the “Odd”). This is the common method of playing the contact sport and provides the most advantages over other team-based games. However, in some embodiments, it may be desirable to split the players into seven or eight teams (or some other number of teams) of doubles. Similarly, teams of triples, quads (four players), quints (five players), etc. may be utilized in other embodiments. In such cases, all team members of the Odd (the offensive player currently in possession of the ball) are called offensive players. Some of the structures of the contact sport may need to be varied to appropriately accommodate games when multiple offensive players are allowed (see below).

In one embodiment, the players all gather in the center of the field around the fifth (or center) scrimmage ring 175. In other embodiments, the players are located in other location(s).

The contact sport 230 of the present invention is launched via the Scrimmaging process 232 which comprises: gathering the players in a generally tight, circular formation facing inwards, placing the players' shoulders side-by-side and wrapping their arms around the shoulders of the players to each side, and leaving a space in the middle into which the referee will drop the ball from above or through the legs of the players. Such a formation is called a scrimmage and is usually formed over the center scrimmage ring 175 although other scrimmage rings 171-174 or locations may be utilized.

Once the scrimmage is formed, the referee introduces the ball into the scrimmage and play begins. Once the ball touches the surface of the playing field 100, the players attempt to seize the ball and escape the scrimmage. Alternatively, one or more players may kick the ball out of the scrimmage.

The process of Gaining Possession of the Ball 233 can begin when a player grabs the ball from inside the scrimmage, or, if the ball has been kicked out of the scrimmage, a player can pick it up outside of the scrimmage. Additionally, retrieving the ball following an Over-the-Shoulder throw, Stealing/Stripping/Slapping the ball from the Odd, Intercepting the Odd's failed pass or field goal kick, or picking up a loose ball that has otherwise legally touched the surface of the playing field all constitute Gaining Possession of the Ball 233. Regardless of which of the above methods are utilized, once a player legally gathers the ball to himself or herself, he or she has gained possession of the ball and becomes the Odd (if playing doubles, triples, quads, quints, etc., all the team members of the Odd, as well as the Odd himself, are called offensive players).

The process of Advancing the Ball 234 is dependent upon whether the Odd is an individual offensive player or if there are others. If the former, the Odd advances towards the active end zone by running with the ball or forward passing the ball to himself or herself. If the latter, the Odd can run the ball towards the active end zone, can lateral pass (i.e., tossing the ball into the air either sideways or backwards relative to the active end zone) the ball to an offensive player, can forward pass the ball to an offensive player, or can hand the ball off to an offensive player.

The active end zone can be either the first end zone 110 or the second end zone 120. When a player first gains possession of the ball, the referee determines the new Odd's position. If the Odd is physically closer to the first end zone 110 then the second end zone 120 becomes the active end zone. Similarly, if the Odd is physically closer to the second end zone 120, then the first end zone 110 becomes the active end zone. If the playing field 100 is equipped with end zone lights 112, 114, 122, and 124 they can be activated accordingly (as described above). Alternatively, the referee or some other means can signal the active end zone.

The goal of the Odd is to bring the ball into the active end zone and touch it to the playing surface while in legal, controlled possession of the ball. The Odd can not maneuver the ball out-of-bounds (across either the first or second side lines 101 and 103 or across either the first or second end lines 102 and 104).

The process of Playing Defense 235 comprises the players who are not offensive players attempting to stop the Odd from advancing the ball to the active end zone. Such players are called defensive players or Muckles. In order to stop the Odd who is carrying the ball, a Muckle can legally tackle the Odd. In another embodiment, touching or otherwise “tagging” the Odd can be an acceptable substitution for tackling. Stealing/Stripping/Slapping the ball from the Odd so that a Muckle then possesses the ball or the ball hits the ground is also an acceptable means of stopping an Odd. Additionally, a Muckle can force the Odd out-of-bounds, off-sides, or to forfeit the ball. A Muckle can also grab the ball while it is in the Odd's possession and if the Odd continues to hold onto the ball a jump ball situation can be called. Finally, a Muckle can play defense by acquiring the ball through Intercepting a failed forward pass or Field Goal attempt.

The process of Testing Special Options 236 can be quite complex. Generally, the Testing process 236 involves determining if scoring has occurred and what actions to take if rules violations have occurred. It can further comprise determining if: a Muckle has legally acquired the ball, general rules violations have occurred, a jump ball situation has occurred, one or more players is out-of-bounds or off-sides, unsportsmanlike conduct has occurred, scoring has occurred, penalties should be assessed, collusion has occurred, a release failure has occurred, a scrimmage infringement has occurred, flopping has occurred, away-from-the-ball infringements have occurred, technical penalties should be assessed, a player should be ejected, etc.

During the Testing Special Options process 236, the referee can penalize players, send them to penalty boxes, eject them, etc. As a result, the referee can call for a new scrimmage to determine a new offensive player and the Scrimmaging process 232 can occur again. Alternatively, a referee can determine that a Muckle's actions were legal and the Gaining Possession of the Ball process 233 occurred legally. In FIG. 2, these options are represented by the first branch arrow 239 which shows that the Testing Special Options process 236 can lead back to the Scrimmaging process 232 or to the Gaining Possession of the Ball process 233. If during the Testing Special Options process 236 it is determined that a scoring event occurred then the Scoring process 237 should initiate.

The Scoring process 237 comprises assigning scores to players based on their actions. When a Muckle legally gains possession of the ball and becomes the new Odd, if he or she then attempts forward progression, two points are awarded (even if the Odd is then immediately tackled, had the ball stolen, etc.). If the Odd successfully possesses the ball in the active end zone and touches the ball to the surface of the playing field, a Touchdown is scored and an additional five points are awarded. Finally, if an Odd does not believe he can reach the end zone, he may kick the ball through the uprights on the goal post of the active end zone and is then awarded one point.

Defensive players may also be awarded points. When a Muckle legally tackles the Odd two points are awarded. If a Muckle forces the Odd out-of-bounds, one point is awarded. If the Odd loses his footing, slides, or otherwise is knocked off his feet (but not tackled) and a Muckle places his hands on the offensive player and holds the Odd to the ground until a referee whistles, the Muckle scores two points. A Muckle who is responsible for knocking the Odd off his feet by checking or pushing the Odd is awarded one point. If a Muckle steals the ball from the Odd by taking the ball from the Odd without the ball touching the ground, the Muckle scores two points for the steal and is also awarded two points for gaining possession of the ball to become the new Odd. If a Muckle strips the ball from the Odd such that the ball hits the ground, the Muckle scores two points. If a Muckle slaps the ball with an open palm so that the Odd loses possession of the ball, the Muckle is awarded two points. Additionally, if a Muckle blocks an attempted Field Goal, one point is awarded.

Defensive scoring can be enhanced if the events occur between the first red zone line 106 and the first end line 102 or between the second red zone line 108 and the second end line 104. These areas are called red zones and the red zone nearest the active end zone is called the active red zone. In one embodiment, if any defensive scoring occurs within the active red zone, then the Muckle receives the normal defensive scoring detailed above as well as a bonus point for each scoring event. For example, tackling the Odd within the active red zone awards an additional one point to the Muckle, so the Muckle receives the standard two points plus one red zone bonus point, or three points total. Forcing the Odd out-of-bounds in the active red zone awards the Muckle an additional one point (two points total). Stealing/Stripping/Slapping the ball from the Odd's possession while within the active red zone awards the Muckle an additional one point (three points total). Gaining possession of the ball in the active red zone may also have a one point bonus in one embodiment, in another embodiment no extra red zone bonus point is awarded for gaining possession of the ball in the active red zone. In other embodiments, scoring can include more or fewer methods of earning points and the points earned can of course vary without departing from the scope of the invention.

Once the Scoring process 237 has been completed, the game can resume with either a scrimmage or a Muckle legally gaining possession of the ball from the Odd. In some instances, the game will not have been stopped and Scoring must occur ‘on-the-fly’ (for instance, if a Muckle legally steals the ball from the Odd, the Muckle immediately becomes the new Odd and advances towards the furthest end zone which is now the active end zone). These options are illustrated in FIG. 2 by the second branch arrow 240 which shows that the Scoring process 237 can lead back to the Scrimmaging process 232 or to the Gaining Possession of the Ball process 233.

The process of Ending the Game 238 occurs when the time has run out or the referees or players otherwise determine that the game should end. This process involves clearing the players from the field and determining the final scores of the players. In one embodiment, the total game time is sixty minutes, divided into three twenty minute periods with ten minutes of intermission between each period. In other embodiments, the game time can vary significantly without departing from the scope of the invention.

In one embodiment of the present invention, it is an object of the present invention to provide a method of playing a game in which an individual offensive player plays against other individual defensive players in an attempt to score as many points as possible. It is another object of the present invention to create a new contact sport (similar to football or rugby) that is played for individual goals and achievements by players that can be played live or can be used to create an electronic or video game. It is a further object of the present invention to enable the game to be played over a playing surface which can easily be located outdoors or within an indoor facility. It is still another object of the present invention to provide a game in which the method of playing the game enables the players to showcase the athletic skills necessary for playing this contact sport.

In another embodiment, the present invention is a game played on a field located outdoors or indoors that is similar in size to a football field. The field is divided into three separate sections, namely a pair of end zones at opposite ends of the field where touchdowns can be scored. The game is played by having the offensive player attempt to advance a ball that is preferably shaped similarly to a rugby ball, through the playing field towards the end zone farthest from the location in which he acquired the ball. When the offensive player crosses the goal line, points are scored by the offensive player. If the offensive player is tackled or pushed out-of-bounds, the offensive player must throw the ball over his shoulder so that one of the defensive players may acquire the ball and become the offensive player until he scores, is tackled, loses possession of the ball, or is pushed out of bounds.

In yet another embodiment, the contact sport is played by a set number of individual players with players held in reserve for possible substitution in the case of ejections or injuries. The game is played with a rugby-style oval ball. The objective of the game is for a single individual offensive player to advance the ball across the field past the farthest goal line from the location he came into possession of the ball. The defensive players attempt to stop the offensive player by either tackling or pushing him out-of-bounds; if this occurs, the offensive player must throw the ball over his shoulder so that a defensive player can acquire the ball and become the new offensive player. The defensive players can force the offensive player to lose possession of the ball. If the offensive player crosses the goal line and enters the end zone, he scores a touchdown and play resets.

When advancing the ball, a player in one embodiment may run with the ball, pass the ball to himself, or kick the ball along the ground or through the air for the purpose of reacquiring the ball and carrying it further down the field of play, thus maintaining his possession of the ball with the potential of scoring a touchdown. Offensive players can prevent themselves from being tackled through his and spin techniques, bumping defensive players, swerving, outside cutting, side stepping, dodging, darting, stopping, and other legal running means. In another embodiment, the Odd may legally forfeit his possession of the ball by dropping it to the ground, tossing the ball into the air, tossing the ball with an over-the-shoulder throw, or kicking the ball without the intention of reacquiring it.

In one embodiment, the defensive players attempt to stop the offensive player from scoring a touchdown, acquire the ball for themselves, and become the offensive player. Defensive players can stop the Odd by tackling him through safe, legal means; holding an Odd while his back, sides, or stomach are touching the ground; stealing/stripping/slapping the ball from the Odd so that the ball either comes into the possession of a defending player or the ball hits the ground; or acquiring the ball by the Odd's forward pass or kick. Defensive players can also force the offensive player out-of-bounds, off-sides, or to forfeit or lose control of the ball. Play restarts after the Odd is tackled, forced out-of-bounds or held while on the ground. The offensive player turns his back on the greatest expanse of the field and tosses the ball with both hands to deliver the ball over his shoulders and backwards into play. After a touchdown, the referees hold a scrimmage at the center of the playing field. After a penalty, the referees hold a scrimmage at the nearest scrimmage ring to the location of the penalty.

In another embodiment, the game is timed and a after a predetermined amount of time the game ends. The game time may stop when the Odd scores a touchdown or field goal, commits a penalty, is injured, or forced out-of-bounds. The game time may stop when a defending player commits a penalty. The game time may stop for referee consultation of a penalty or instant replay.

In yet another embodiment, the ball is considered loose if: the ball escapes the scrimmage without being in possession of any player, the ball hits the ground through an over-the-shoulder throw, or it is stolen/stripped/or slapped froth the possession of the offensive player. Also, if the ball hits the ground because of an offensive players failed forward pass, failed kick, or forfeiture. Loose balls may be kicked by any player with the goal of preventing opposing players from seizing the ball. Loose balls may not be advanced more than 20 yards from the spot they become “loose” and touched the ground. If this occurs it is considered off-sides and a scrimmage is required. When a loose ball is acquired by a player, this player becomes the Odd and must proceed to the farthest end zone.

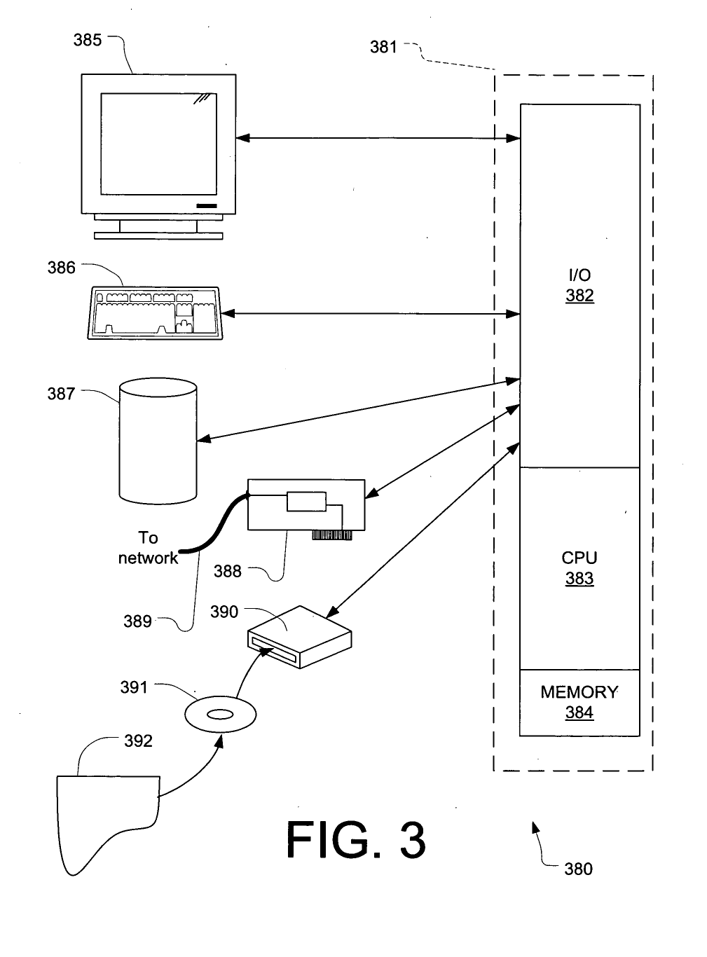

FIG. 3 illustrates an exemplary embodiment of a computing system 380 useful in implementations of the described invention. The computing system 380 can be a desktop computer, a laptop computer, a netbook computer, a notepad computer, a personal digital assistant, a mobile phone computing device, a video game system, etc. The contact sport can be played by live people on an indoor or outdoor playing field or it can be played on an electronic playing field using a computing system 380 device.

A general purpose computer system 380 is capable of executing a computer program product to execute a computer process. Data and program files may be input to the computer system 380, which reads the files and executes the programs therein. Some of the elements of a general purpose computer system 380 are shown in FIG. 3 wherein a processor 381 (having one or more cores) is shown having an input/output (I/O) section 382, a Central Processing Unit (CPU) section 383, and a memory section 384. There may be one or more processors 381, such that the processor 381 of the computer system 380 comprises a single central-processing unit section 383, or a plurality of processing units, commonly referred to as a parallel processing environment. The computer system 380 may be a conventional computer, a distributed computer, or any other type of computer. The described technology is optionally implemented in software devices loaded in memory 384, stored on a configured DVD/CD-ROM/OPTICAL DISC 391 or storage unit 387, and/or communicated via a wired or wireless network link 389 on a carrier signal, thereby transforming the computer system 380 in FIG. 3 into a special purpose machine for implementing the described operations.

The I/O section 382 is connected to one or more user-interface devices (e.g., a keyboard 386 and a display unit 385), a disk storage unit 387, and a disk drive unit 390. Generally, in contemporary systems, the disk drive unit 390 is a DVD/CD-ROM/OPTICAL drive unit capable of reading the DVD/CD-ROM/OPTICAL DISC medium 391, which typically contains programs and data 392. However, other types of external storage units may be used in addition to or in place of the disk drive unit 390. Computer program products containing mechanisms to effectuate the systems and methods in accordance with the described technology may reside in the memory section 384, on a disk storage unit 387, on an external storage unit, or on the DVD/CD-ROM/OPTICAL medium 391 of such a system 380. Alternatively, a disk drive unit 390 may be replaced or supplemented by a floppy drive unit, a tape drive unit, or other storage medium unit. The network adapter 388 is capable of connecting the computer system to a network via the network link 389, through which the computer system can receive instructions and data embodied in a carrier wave. Examples of such systems include SPARC systems offered by Sun Microsystems, Inc., personal computers offered by Dell Corporation and by other manufacturers of personal computers, Apple-based computing systems, ARM-based computing systems and other systems running a UNIX-based or other operating system. It should be understood that computing systems may also embody devices such as Personal Digital Assistants (PDAs), mobile phones, smart phones, gaming consoles, set top boxes, etc.

When used in a LAN-networking environment, the computer system 380 is connected (by wired connection or wirelessly) to a local network through the network interface or adapter 388, which is one type of communications device. When used in a WAN-networking environment, the computer system 380 typically includes a modem, a network adapter, or any other type of communications device for establishing communications over the wide area network. In a networked environment, program modules depicted relative to the computer system 380 or portions thereof, may be stored in a remote memory storage device. It is appreciated that the network connections shown are exemplary and other means of, and devices for, establishing a communications link between the computers may be used.

In accordance with an implementation, software instructions and data directed toward implementing a contact sport game and other operations may reside on disk storage unit 387, disk drive unit 390 or other storage medium units coupled to the system (directly and/or through a network interface 388). Said software instructions may also be executed by CPU 383.

The embodiments of the invention described herein can be implemented as logical steps in one or more computer systems. The logical operations of the present invention are implemented (1) as a sequence of processor-implemented steps executing in one or more computer systems and/or (2) as interconnected machine or circuit modules within one or more computer systems. The implementation is a matter of choice, dependent on the performance requirements of the computer system implementing the invention. Accordingly, the logical operations making up the embodiments of the invention described herein may be referred to variously as processes, operations, steps, objects, or modules. Furthermore, it should be understood that logical operations may be performed in any order, unless explicitly claimed otherwise or a specific order is inherently necessitated by the claim language.

The above specification, examples and data provide a description of the structure and use of exemplary embodiments of the described articles of manufacture and methods. It will further be understood from the foregoing description that various modifications and changes may be made in the embodiments of the present invention without departing from its true spirit. This description is intended for purposes of illustration only and should not be construed in a limiting sense. The scope of this invention should be limited only by the language of the following claims.

1. A playing field for a contact sport, the field comprising:
a first sideline positioned generally parallel to a second sideline and a first end line positioned generally parallel to a second end line, wherein a first end of the first sideline is in proximity to a first end of the first end line, a second end of the first sideline is in proximity to a first end of the second end line, a first end of the second sideline is in proximity to a second end of the first end line, and a second end of the second sideline is in proximity to a second end of the second end line;
a first end zone having a width less than the distance between the first sideline and the second sideline at the point where the first sideline and second sideline are in proximity to the first end line, and the first end zone being generally centered between the first sideline and the second sideline with the first end line forming a portion of the boundary of the first end zone;
a second end zone having a width less than the distance between the first sideline and the second sideline at the point where the first sideline and second sideline are in proximity to the second end line, and the second end zone being generally centered between the first sideline and the second sideline with the second end line forming a portion of the boundary of the second end zone;
a plurality of scrimmage rings, wherein at least one of the rings is located at generally a center of the playing field;
a plurality of penalty boxes positioned outside of an area generally enclosed by the first sideline, the second sideline, the first end line, and the second end line;
a first plurality of negative yardage areas positioned in proximity to the first end line and bordered by the first end zone; and
a second plurality of negative yardage areas positioned in proximity to the second end line and bordered by the second end zone.

2. The playing field of claim 1 further comprising:
a first goal post positioned in proximity to the first end line and the first end zone; and
a second goal post positioned in proximity to the second end line and the second end zone.

3. The playing field of claim 2 wherein the first goal post has a plurality of indicators to indicate whether the first end zone is active.

4. The playing field of claim 3 wherein the second goal post has a plurality of indicators to indicate whether the second end zone is active.

5. The playing field of claim 1 further comprising:
a first red zone line, wherein a first end of the first red zone line is in proximity to the first sideline and a second end of the first red zone line is in proximity to the second sideline and the first red zone line is positioned between the center of the field and the first end line; and
a second red zone line, wherein a first end of the second red zone line is in proximity to the first sideline and a second end of the second red zone line is in proximity to the second sideline and the second red zone line is positioned between the center of the field and the second end line.

6. A method of playing a contact sport utilizing the playing field of claim 1, the method comprising the steps of:
beginning a contact sport game;
scrimmaging, wherein the scrimmaging takes place at one of the plurality of scrimmage rings;
gaining possession of a ball, wherein a player who gains possession of the ball becomes an Odd;
advancing the ball, wherein the Odd advances the ball towards an active end zone;
playing defense, wherein the players who are not on offense attempt to stop the Odd from advancing the ball;
testing special options;
scoring; and
ending the game.

7. A method of playing a contact sport utilizing the playing field of claim 2, the method comprising the steps of:
beginning a contact sport game;
scrimmaging, wherein the scrimmaging takes place at one of the plurality of scrimmage rings;
gaining possession of a ball, wherein a player who gains possession of the ball becomes an Odd;
advancing the ball, wherein the Odd advances the ball towards an active end zone;
playing defense, wherein the players who are not on offense attempt to stop the Odd from advancing the ball;
testing special options;
scoring; and
ending the game.

8. A method of playing a contact sport utilizing the playing field of claim 3, the method comprising the steps of:
beginning a contact sport game;
scrimmaging, wherein the scrimmaging takes place at one of the plurality of scrimmage rings;
gaining possession of a ball, wherein a player who gains possession of the ball becomes an Odd;
advancing the ball, wherein the Odd advances the ball towards an active end zone, the active end zone indicated by the plurality of indicators;
playing defense, wherein the players who are not on offense attempt to stop the Odd from advancing the ball;
testing special options;
scoring; and
ending the game.

9. A method of playing a contact sport utilizing the playing field of claim 5, the method comprising the steps of:
beginning a contact sport game;
scrimmaging, wherein the scrimmaging takes place at one of the plurality of scrimmage rings;
gaining possession of a ball, wherein a player who gains possession of the ball becomes an Odd;
advancing the ball, wherein the Odd advances the ball towards an active end zone, the active end zone indicated by the plurality of indicators;
playing defense, wherein the players who are not on offense attempt to stop the Odd from advancing the ball;
testing special options;
scoring; and
ending the game.

10. A method of playing a contact sport utilizing a playing field, the method comprising the steps of:
beginning a contact sport game on the playing field, wherein the playing field comprises:
(A) a first sideline positioned generally parallel to a second sideline and a first end line positioned generally parallel to a second end line, wherein a first end of the first sideline is in proximity to a first end of the first end line, a second end of the first sideline is in proximity to a first end of the second end line, a first end of the second sideline is in proximity to a second end of the first end line, and a second end of the second sideline is in proximity to a second end of the second end line;
(B) a first end zone having a width less than the distance between the first sideline and the second sideline at the point where the first sideline and second sideline are in proximity to the first end line, and the first end zone being generally centered between the first sideline and the second sideline with the first end line forming a portion of the boundary of the first end zone;
(C) a second end zone having a width less than the distance between the first sideline and the second sideline at the point where the first sideline and second sideline are in proximity to the second end line, and the second end zone being generally centered between the first sideline and the second sideline with the second end line forming a portion of the boundary of the second end zone;
(D) a plurality of scrimmage rings, wherein at least one of the rings is located at generally a center of the playing field;
(E) a plurality of penalty boxes positioned outside of an area generally enclosed by the first sideline, the second sideline, the first end line, and the second end line;
(F) a first plurality of negative yardage areas positioned in proximity to the first end line and bordered by the first end zone; and
(G) a second plurality of negative yardage areas positioned in proximity to the second end line and bordered by the second end zone.
scrimmaging, wherein the scrimmaging takes place at one of the plurality of scrimmage rings;
gaining possession of a ball, wherein a player who gains possession of the ball becomes an Odd;
advancing the ball, wherein the Odd advances the ball towards an active end zone;
playing defense, wherein the players who are not on offense are called defensive players and the defensive players attempt to stop the Odd from advancing the ball;
testing special options, wherein, a referee determines if scoring has occurred, if rules violations have occurred, and what actions to take;
scoring; and
ending the game.

11. The method of claim 10 wherein the step of scoring further comprises:
assigning points to the Odd based on actions of the Odd;
assigning points to the defensive players; and
resuming the game.

12. The method of claim 10 wherein the step of ending the game comprises a referee determining if a predetermined game time has elapsed and if it has, the referee signals the end of the game.

13. The method of claim 10 further comprising:
the Odd has a partner player;
both the Odd and the partner player are called offensive players;
and wherein the offensive players may hand off and pass the ball between one another in order to advance the ball towards the active end zone.

14. The method of claim 10 further comprising:
the Odd has a first partner player and a second partner player;
all of the Odd, the first partner player, and the second partner player are called offensive players;
and wherein the offensive players may hand off and pass the ball between one another in order to advance the ball towards the active end zone.

15. The method of claim 10 further comprising:
the Odd has a first partner player, a second partner player, and a third partner player;
all of the Odd, the first partner player, the second partner player, and the third partner player are called offensive players;
and wherein the offensive players may hand off and pass the ball between one another in order to advance the ball towards the active end zone.

16. The method of claim 10 further comprising:
the Odd has a first partner player, a second partner player, a third partner player, a fourth partner player, and a fifth partner player;
all of the Odd, the first partner player, the second partner player, the third partner player, the fourth partner player, and the fifth partner player are called offensive players;
and wherein the offensive players may hand off and pass the ball between one another in order to advance the ball towards the active end zone.

17. A computer program product encoding a computer program for a computer process that executes on a computer system implementing a contact sport game played on an electronic representation of a playing field, the computer process comprising:
beginning a contact sport game on the electronic representation of the playing field, wherein the representation of the playing field comprises:
(A) a first sideline positioned generally parallel to a second sideline and a first end line positioned generally parallel to a second end line, wherein a first end of the first sideline is in proximity to a first end of the first end line, a second end of the first sideline is in proximity to a first end of the second end line, a first end of the second sideline is in proximity to a second end of the first end line, and a second end of the second sideline is in proximity to a second end of the second end line;
(B) a first end zone having a width less than the distance between the first sideline and the second sideline at the point where the first sideline and second sideline are in proximity to the first end line, and the first end zone being generally centered between the first sideline and the second sideline with the first end line forming a portion of the boundary of the first end zone;
(C) a second end zone having a width less than the distance between the first sideline and the second sideline at the point where the first sideline and second sideline are in proximity to the second end line, and the second end zone being generally centered between the first sideline and the second sideline with the second end line forming a portion of the boundary of the second end zone;
(D) a plurality of scrimmage rings, wherein at least one of the rings is located at generally a center of the playing field;
(E) a plurality of penalty boxes positioned outside of an area generally enclosed by the first sideline, the second sideline, the first end line, and the second end line;
(F) a first plurality of negative yardage areas positioned in proximity to the first end line and bordered by the first end zone; and
(G) a second plurality of negative yardage areas positioned in proximity to the second end line and bordered by the second end zone.
scrimmaging, wherein the scrimmaging takes place at one of the plurality of scrimmage rings;
gaining possession of a ball, wherein a player who gains possession of the ball becomes an Odd;
advancing the ball, wherein the Odd advances the ball towards an active end zone;
playing defense, wherein the players who are not on offense are called defensive players and the defensive players attempt to stop the Odd from advancing the ball;
testing special options, wherein a referee determines if scoring has occurred, if rules violations have occurred, and what actions to take;
scoring; and
ending the game.

18. The method of claim 17 wherein the step of scoring further comprises:
assigning points to the Odd based on actions of the Odd;
assigning points to the defensive players; and
resuming the game.

19. The method of claim 17 wherein the step of ending the game comprises a computer process determining if a predetermined game time has elapsed and if it has, the computer process signals the end of the game.

20. The method of claim 17 further comprising:
the Odd has at least one partner player;
both the Odd and the at least one partner player are called offensive players;
and wherein the offensive players may hand off and pass the ball between one another in order to advance the ball towards the active end zone.
